(19) United States
(12) Patent Application Publication
(10) Pub. No.: US 2007/0056208 A1
(43) Pub. Date: Mar. 15, 2007

(54) Mosquito trap mediated by filtrated visible light emitting diode and mosquito bait

(76) Inventors: Chien-Lung Chen, Tainan City (TW); Hao-Jan Lin, Taipei (TW)

Correspondence Address: J.C. Patents, Inc., Suite 250, 4 Venture, Irvine, CA, 92618, US

(21) Appl. No.: 11/400,562

(22) Filed: Apr. 7, 2006

(30) Foreign Application Priority Data
Sep. 13, 2005 (TW) 94131435

(51) Int. Cl. A01M 1/08; A01M 1/04

(52) U.S. Cl. 43/113; 43/139

(57) ABSTRACT

The present invention provides a LED mosquito trap lamp combined with a mosquito bait. The mosquito trap lamp uses ultra-violet light and the mosquito bait for attracting the mosquitoes, while the ultra-violet light is provided by using visible light LEDs in combination of the filter. Because the ultra-violet light is provided by using the visible light wavelength LEDs in combination of the filter, the costs of the mosquito trap lamp can be reduced and the luminance can be maintained. By using the visible light LEDs in combination of the filter, the light emitting from the mosquito trap lamp is stable and the lifetime of the mosquito trap lamp can be extended.

### CROSS-REFERENCE TO RELATED APPLICATION

This application claims the priority benefit of Taiwan application serial no. 94131435, filed on Sep. 13, 2005. All disclosure of the Taiwan application is incorporated herein by reference.

### BACKGROUND OF THE INVENTION

1. Field of Invention

The present invention relates to an apparatus for trapping mosquitoes and insects. More particularly, the present invention relates to a mosquito trap lamp apparatus.

2. Description of Related Art

In warm and humid environments, mosquitoes have been a nuisance to the human beings. Not only its bites cause irritation and itchiness, mosquitoes may even epidemically transmit diseases, such as malaria, dengue fever, and Japanese meningitis, to individuals.

Mosquito-related products available in current markets include mosquito-repellent formulated as coil, pastille, or aerosols, and mosquito trap lamps. In most cases, the mosquito trap lamps employ ultra-violet (UV) light sources or fluorescent light sources for attracting insects. However, the airtight discharging lamp commonly used in the mosquito trap lamps is easily decayed over a short period of time and provides a broad region of spectrum, which may contain dangerous UV light causing damages of human eyes.

The mosquito trap lamps may further employ mosquito baits for enhancing the attraction of mosquitoes, and the attractants are of CO2, highly volatile 1-octen-3-ol, pheromones, and compounds derived from human sweat, i.e. L-lactic acid, dibutyl succinate, or dimethyl disulfide. The inventors previously proposed to use microbial fermentation products as the mosquito attractant in terms of simulating the human sweat odors (U.S. Pat. No. 6,823,622). Nevertheless, it has been noticed that those mosquito attractants of pheromones, sweat chemicals or microbial fermentation solution are low volatility which results in mediocre attractive effects toward thus distant habitation of mosquitoes. Although highly volatile polar or non-polar solvents can be used to expel the attractants as aerosols, the highly volatile solvents in high concentrations may be harmful to human being. Hence, the resultant products are not suitable for using in closed spaces or indoors.

### SUMMARY OF THE INVENTION

This invention provides a mosquito trap lamp, which employs visible light LED with filters (filtrated visible light LED) for emitting UV lights. Instead of using gas discharging lamps, the lifetime of the mosquito lamp can be extended.

This invention provides a mosquito trap lamp, which employs a filtrated LED visible light set for emitting UV lights. Instead of using UV LED, the costs of the mosquito lamp can be decreased.

This invention also provides a mosquito trap lamp, which uses the piezoelectric vibrator for assisting the emanation of the mosquito bait(s) and for enhancing the efficiency of mosquito attraction. Moreover, the mosquito trap lamp can be used in closed environments or indoors.

As embodied and broadly described herein, the invention provides a mosquito trap lamp apparatus, including at least a casing, a lid, a LED light set, a power supply and a mosquito destroying device. The LED light set is disposed on the lid and includes at least a bulb socket set, a visible light LED (bulb) disposed on the bulb socket set, and at least an ultra-violet (UV) band-pass filter covering the visible light LED on the bulb socket set. The apparatus may further include a fan disposed under the lid and within the compartment.

As embodied and broadly described herein, the mosquito lamp apparatus described above also includes a mosquito bait for enhancing attraction toward mosquitoes or insects and/or a bait-releasing unit for helping the discharge of the mosquito bait or its odors. The bait-releasing unit can be designed to employ the piezoelectric vibrator for assisting the emanation of the mosquito bait(s), in a physical and safer way. Moreover, a plurality of holes or slots can be designed on sidewalls of the casing or the lid for assisting air flow or odor emanation.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a display cross-sectional view, from the front, of an apparatus according to one preferred embodiment of the invention.

FIG. 1B is a display cross-sectional view, from one side, of an apparatus according to one preferred embodiment of the invention.

FIG. 1C is a display top view of an apparatus according to one preferred embodiment of the invention.

FIG. 1D is a display view for emanation of the mosquito bait from the bait container in conjunction with the bait-releasing unit according to one preferred embodiment of the invention.

FIG. 2 is a perspective view of a light set of the apparatus according to one preferred embodiment of the present invention.

FIG. 2A is a partially enlarged perspective view of the light set shown in FIG. 2.

### DESCRIPTION OF THE PREFERRED EMBODIMENTS

Although the term “mosquito trap lamp” is used herein and in the following contexts, the apparatus described hereafter is not limited to attract, trap or kill mosquitoes, but also may be applied to attract, trap or kill all other kinds of light or photo-tactic insects. Moreover, the apparatus of this invention is not limited to lamp shapes, but can be considered as light traps.

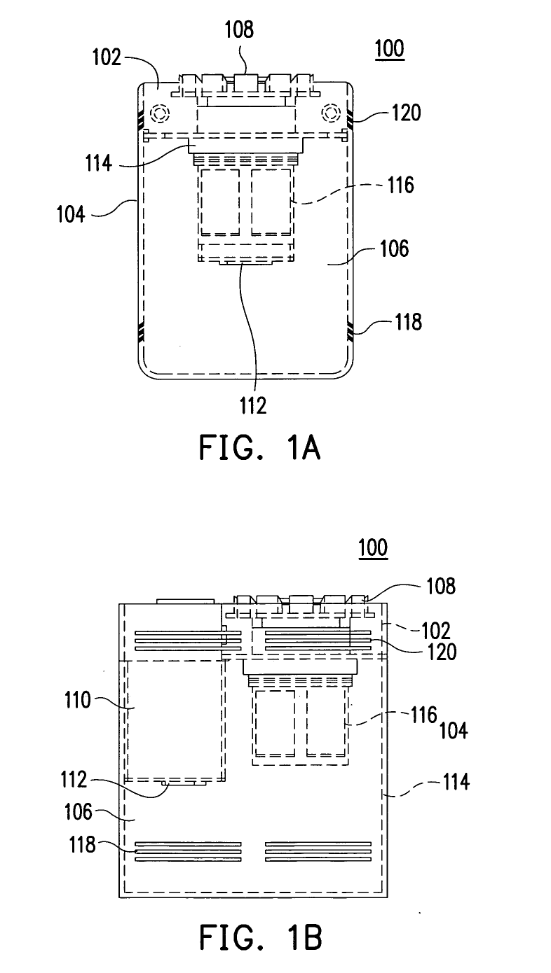

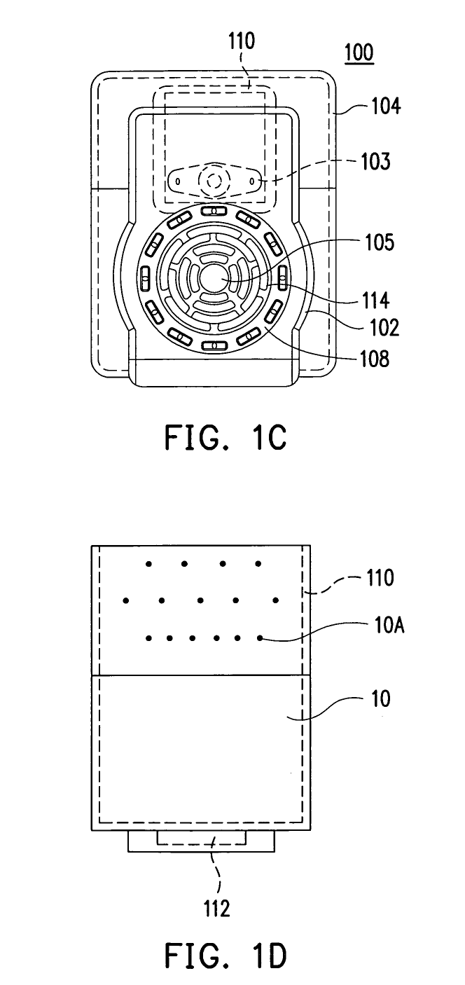

FIGS. 1A-1B are schematic cross-sectional views of an apparatus according to one preferred embodiment of the invention from two directions respectively. FIG. 1C is a schematic top view of the apparatus in FIGS. 1A-1B. Referring to FIGS. 1A-1C, the mosquito trap lamp or apparatus 100 includes a lid or shield 102 disposed on top of the casing 104. The casing 104 is connected to the lid 102 through a tight-fitting mechanism or other connecting means including screws, bolts, rivets or nails or the lid 102 can be engaged to the casing 104 through a push button. A compartment 106 is defined by the lid 102 and the casing 104. The apparatus 100 also includes a light emitting diode (LED) light set 108, disposed in the lid 102. The LED light set 108 can face inward for emitting lights into the compartment for attracting mosquitoes to the trap. Alternatively, the LED light set can faces outwards toward the surroundings. The design of the light set 108 will be described in more details later.

The apparatus 100 further includes a mosquito bait container 110 and a bait-releasing unit 112, disposed within the compartment 106. The bait container 110 may be designed to be detachably fixed below the lid 102 but disposed within the compartment 106 or be detachably fixed in the compartment 106. Preferably, the bait container 110 is detachably fixed below the lid 102 and disposed within the compartment 106, and the lid 102 has an opening 103 for refilling the bait or replacing the container 110. Alternatively, the casing 104 may be designed to have an opening (not shown) for refilling the bait or replacing the container 110. The bait container 110 has at least a mosquito bait, and the mosquito bait includes at least a mosquito attractant. For example, the mosquito attractants can be selected from CO2, 1-octen-3-ol, pheromones, L-lactic acid, dibutyl succinate or dimethyl disulfide, or even microbial (bacterial) fermentation products as disclosed in U.S. Pat. No. 6,823,622 (The entire disclosure of U.S. Pat. No. 6,823,622, filed on Jul. 19, 2002, is incorporated by reference). In this embodiment, the metabolites or fermentation products from specific bacterium strain cultivated in a predetermined medium is used as the mosquito attractant. The mosquito bait container 110 can be a gas tank, a bottle, a tube, a box or a cassette, depending on whether the mosquito bait is in gas, liquid or solid state or in other forms (gel or powers). Preferably, the mosquito bait is in a liquid state and suitable to be employed in conjunction with the bait-releasing unit 112.

According to this embodiment, as shown in FIG. 1D, the bait-releasing unit 112 is disposed under the bait container 110. The bait-releasing unit 112, designed based on electronic vibration, uses the ceramic piezoelectric vibrator for generating high frequency vibration wave (supersonic wave) to vaporize the mosquito bait solution 10 into tiny or minute droplets (mist) 10A, for better emanation. This design for releasing baits based on physical method is safer and suitable for the outdoors, indoors use or in a closed space. Moreover, in the use in outdoors, indoors or a closed space, the bait-releasing unit 112 can increase the efficiency for attracting mosquitoes significantly. For example, under the supersonic wave of 1.6 million hertz (MHz), the vaporized particles (droplet) of water have diameters of about 3 microns. In general, using electronic circuits for controlling the frequency of the vibrator, it is possible to control diameters of the vaporized particles (droplet) of the bait liquid ranging from 0.5-6 microns, for example. Since the vaporized mist of the bait liquid can easily travel along with the gas flow, the odors of the bait can be spread out to increase the attraction for mosquitoes or insects. In this embodiment, the parameters of the supersonic vibrator are as follows: [symbol] frequency (Hz): 1.6 MHz˜2.5 MHz, resistance (Ω)≦2.0, capacitance (PF): 1200˜2000 [symbol] . By using the vibrator, the bait liquid is vaporized into minute droplets for easy emanation and the effective distance for attracting mosquitoes can be increased.

Referring back to FIGS. 1A-1C, the apparatus includes a fan 114 set under the lid 102. The major part of the fan 114 is disposed within the compartment 106. The fan 114 can be designed to blow air inwardly or the fan 114 is used in combination with a vacuum pump (not shown) for drawing air inwardly for trapping mosquitoes or insects and for helping odor emanation.

The compartment 106 further includes a mosquito destroying device 116, for example, an insect web, an electric grid (web) or a sticky web with or without a pesticide. Preferably, the insect web is employed to trap the allured mosquitoes or insects and the trapped mosquitoes are killed naturally by dehydration. A plurality of ventilation holes or slots 118 is disposed along the sidewalls of the casing 104 and/or a plurality of holes or slots 120 is disposed along the edge of the lid 102. In fact, the holes or slots 118 and 120 consist of airing pathways for assisting air flow or ventilation, and assisting the release or oozing of the vaporized bait droplets for odor emanation. A power supply (not shown) is included in the apparatus 100 for supplying electricity to the light set 108, the bait-releasing unit 112, the fan 114 and/or the electric grid. If the apparatus is applied for indoor uses, the power supply can be coupled to a DC power source by a plug. However, the power supply can be powered through batteries or solar cells, if the apparatus 100 is designed as portable or applied outdoors. The design of the power supply is well known to one skilled in the art and will not be described in details herein.

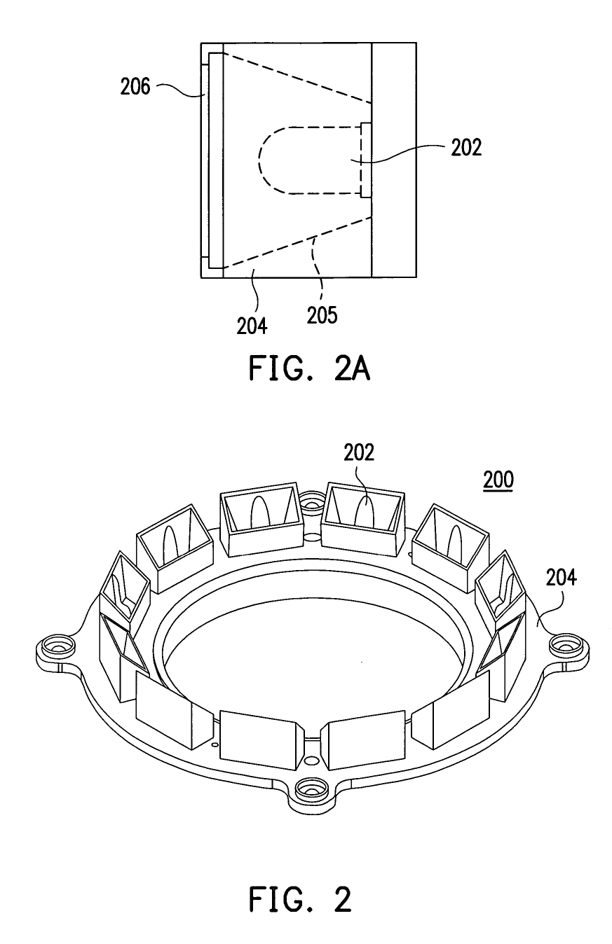

FIG. 2 is a perspective view of a light set of the apparatus according to one preferred embodiment of the present invention, while FIG. 2A is a partially enlarged perspective view of the light set shown in FIG. 2.

As shown in FIGS. 2 and 2A, the light set 200 includes a group of visible light emitting diodes (LEDs) 202 disposed on a (bulb) socket set 204. For each LED 202, a filter sheet or film 206 covers the visible light LED to screen the wavelength of (filter out) the light emitting from the LED 202. Because a plurality of LEDs is used, the light intensity (brightness or luminance) is increased. In this embodiment, the socket set 204 is in a ring shape so that lights from the LED bulb loop are concentrated for boosting luminance. However, the shape of the socket set 204 is not limited to ring shaped, but can be in various shapes, including an ellipse, oval, a circle, star or polygon, for example. The socket set 204 is designed to be hollow in the central portion for the convenience of setting the fan 114. Alternatively, the socket set 204 can be designed to be non-hollow in the central portion and the fan is disposed aside. Referring to FIG. 2A, below each LED bulb 202, a reflective surface or mirror 205 is further included in the socket set 204 for assisting the concentration or focus of lights from LED bulbs 202.

In this embodiment, the LED 202 is a LED emitting lights in visible light wavelengths (i.e. visible light LED in the range of 380 to 780 nm wavelength). However, LEDs in other wavelengths can be applicable. The filter sheet or film 206 is used to screen the light emitting from the LED bulbs and allows UV light (about 360 nm to 370 nm) passing through. That is, the visible light LEDs in combination with the filter sheet 206 emit lights in the region of UV spectrum.

The filter sheet or film 206 can be a thin film filter, for example. Preferably, the thin film filter can be a band-pass thin film filter, fabricated by vapor depositing multiple highly reflective TiO2 or Ti2O5 film layers repeatedly on a low reflective optical glass substrate, for passing certain band of wavelengths and filtering out wavelengths in other ranges. In this embodiment, the filter sheet 206 is a UV band-pass thin film filter glass slide. However, the filter sheet 206 is not limited by the embodiments herein, as long as the filter sheet 206 can filter out undesired wavelengths and allow UV lights passing through.

In summary, the mosquito trap lamp or apparatus described in this invention can be designed to be used indoors or outdoors, or to be portable or fixed to the walls, cars, or other suitable positions. The shapes or layouts of the mosquito lamp or apparatus described in this invention can be varied or adjusted according to requirements of fabrication or intended applications, cost considerations or appeals to potential consumers.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A mosquito trap lamp apparatus, for use indoors or outdoors, comprising:
a casing;
a lid, disposed on the casing, wherein a compartment is defined by the casing and the lid;
a light emitting diode (LED) light set, disposed on the lid, wherein the LED light set comprises at least a visible light LED, and the visible light LED is covered by an ultra-violet (UV) band-pass filter;
a bait container disposed in the compartment, wherein the bait container comprises a mosquito bait;
a bait-releasing unit disposed in the compartment and below the bait container;
a fan disposed under the lid and in the compartment;
a mosquito destroying device disposed in the compartment and below the fan; and
a power supply disposed in the compartment, wherein a plurality of holes is disposed on sidewalls of the lid and the casing and the holes consist of airing pathways for assisting air flow.

2. The apparatus as claimed in claim 1, wherein the LED light set further comprises a bulb socket set and the visible light LED is disposed on the bulb socket set, and the UV band-pass filter covers the visible light LED and the bulb socket set.

3. The apparatus as claimed in claim 1, wherein the LED light set further comprises a reflective surface disposed the visible light LED on the bulb socket set.

4. The apparatus as claimed in claim 1, wherein the bait-releasing unit comprises a ceramic piezoelectric vibrator.

5. The apparatus as claimed in claim 1, wherein the bait container is detachably fixed within the compartment.

6. The apparatus as claimed in claim 1, wherein the bait container is detachably fixed below the lid and disposed within the compartment.

7. The apparatus as claimed in claim 1, wherein the fan draws air inwardly to engulf mosquitoes or insects and to assist odor emanation together with the airing pathways.

8. The apparatus as claimed in claim 1, wherein the fan is used in combination with a vacuum pump for drawing air inwardly for trapping mosquitoes or insects.

9. The apparatus as claimed in claim 1, wherein the mosquito destroying device comprises an electric grid.

10. The apparatus as claimed in claim 1, wherein the mosquito destroying device comprises a sticky web.

11. The apparatus as claimed in claim 1, wherein the mosquito destroying device comprises an insect web.

12. The apparatus as claimed in claim 1, wherein the lid has an opening for replacing the bait container or refilling the mosquito bait.

13. The apparatus as claimed in claim 1, wherein the mosquito bait comprises a material selected from the group consisting of CO₂, 1-octen-3-ol, pheromones, L-lactic acid, dibutyl succinate, dimethyl disulfide, and a microbial fermentation product.

14. The apparatus as claimed in claim 1, wherein the UV band-pass filter is an UV band-pass filter glass slide.

15. The apparatus as claimed in claim 14, wherein UV light has a wavelength of about 360 nm-370 nm.

16. A mosquito trap lamp apparatus, comprising:
a casing;
a lid, disposed on the casing, wherein a compartment is defined by the casing and the lid;
a light emitting diode (LED) light set, disposed on the lid, wherein the LED light set comprises at least a visible light LED, a bulb socket set and at least an ultra-violet (UV) band-pass filter, wherein the visible light LED is disposed on the bulb socket set, and the UV band-pass filter covers the visible light LED on the bulb socket set; and
a fan disposed under the lid and in the compartment;
a mosquito destroying device disposed in the compartment and below the fan; and
a power supply disposed in the compartment, wherein a plurality of ventilation holes is disposed on sidewalls of the casing for assisting air flow.

17. The apparatus as claimed in claim 16, wherein the LED light set further comprises a reflective surface disposed below the visible light LED and disposed on the bulb socket set.

18. The apparatus as claimed in claim 16, wherein the fan draws air inwardly to engulf mosquitoes or insects and to assist odor emanation together with the airing pathways.

19. The apparatus as claimed in claim 16, wherein the fan is used in combination with a vacuum pump for drawing air inwardly for trapping mosquitoes or insects.

20. The apparatus as claimed in claim 16, wherein the mosquito destroying device comprises an electric grid.

21. The apparatus as claimed in claim 16, wherein the mosquito destroying device comprises a sticky web.

22. The apparatus as claimed in claim 16, wherein the mosquito destroying device comprises an insect web.

23. The apparatus as claimed in claim 16, further comprising a bait container disposed in the compartment, wherein the bait container comprises a mosquito bait.

24. The apparatus as claimed in claim 23, further comprising a bait-releasing unit disposed in the compartment and below the bait container, for emanating odors of the mosquito bait.

25. The apparatus as claimed in claim 23, wherein the mosquito bait comprises a material selected from the group consisting of CO₂, 1-octen-3-ol, pheromones, L-lactic acid, dibutyl succinate, dimethyl disulfide, and a microbial fermentation product.
